(19) United States
(12) Patent Application Publication
(10) Pub. No.: US 2026/0320124 A1
(43) Pub. Date: Oct. 15, 2026

(54) GRAPH-BASED DOCUMENT RETRIEVAL DEVICE AND METHOD

(71) Applicant: SAMSUNG SDS CO., LTD., Seoul (KR)

(72) Inventors: Dong Woo KIM, Seoul (KR); Joon Yi KIM, Seoul (KR); Jae Sun SHIN, Seoul (KR); Hye Rim HONG, Seoul (KR); Min Young LEE, Seoul (KR)

(73) Assignee: SAMSUNG SDS CO., LTD., Seoul (KR)

(21) Appl. No.: 19/345,784

(22) Filed: Sep. 30, 2025

(30) Foreign Application Priority Data
Apr. 11, 2025 (KR) 10-2025-0047667

(51) Int. Cl. G06F 16/901; G06F 16/93

(52) U.S. Cl. CPC G06F 16/9024; G06F 16/93

(57) ABSTRACT

Provided are a graph-based document retrieval device and method. The graph-based document retrieval method includes generating a graph having a plurality of documents as document nodes and one or more queries associated with each of the documents as query nodes, generating embedding vectors corresponding to the document nodes and the query nodes, and retrieving one or more documents associated with an input query among the plurality of documents based on the embedding vectors.

### CROSS REFERENCE TO RELATED APPLICATION

This application claims priority from Korean Patent Application No. 10-2025-0047667, filed on Apr. 11, 2025, which is hereby incorporated by reference for all purposes as if fully set forth herein.

### BACKGROUND

Embodiments of the disclosure relate to information retrieval technology.

Existing document retrieval systems generally use embedding models to map documents and queries to a vector space and perform similarity-based retrieval between documents and queries. This approach has good performance when pre-trained for a particular domain but suffers from degraded document retrieval performance when new documents are added to the system due to the gap between new data and existing data. To reduce these limitations, various methods such as data fine-tuning, contrastive learning, or maximum mean discrepancy (MMD)-based domain adaptation methods have been proposed. However, these methods have drawbacks such as high additional training costs and the inability to guarantee the performance of the original model.

Recently, a hypothetical document embedding (HyDE) technique has been proposed, which generates virtual documents in response to input queries using a large language model (LLM) to improve retrieval performance. However, this technique also requires calling the LLM during each inference, thereby resulting in inefficiency in terms of real-time processing and resource costs. Existing graph-based document extraction techniques either consider only the relationships between documents or rely on entity-based connections. Consequently, the ability to encompass the semantic diversity of queries is limited, and flexible expansion to new data is difficult.

The information disclosed in the Background section is only provided for a better understanding of the background and should not be taken as an acknowledgment or any form of suggestion that this information forms prior art that would already be known to a person having ordinary skill in the art.

### SUMMARY

Embodiments of the disclosure are intended to provide technical means for efficiently retrieving documents using a graph structure which models the relationships between documents and queries.

According to example embodiments, provided is a graph-based document retrieval method performed by a computing device, wherein the computing device includes: one or more processors; and a memory which stores one or more programs to be executed by the one or more programs, the graph-based document retrieval method including: generating a graph having a plurality of documents as document nodes and one or more queries associated with each of the plurality of documents as query nodes; generating embedding vectors corresponding to the document nodes and the query nodes; and retrieving one or more documents associated with an input query among the plurality of documents based on the embedding vectors.

In an embodiment, the generating of the graph may include generating an edge between each of the query nodes and a document node associated with each of the query nodes.

In an embodiment, the generating of the graph may include: generating, from a document having no associated queries or a specific or smaller number of associated queries, one or more hypothetical queries associated with the document; and adding the generated one or more hypothetical queries to the graph as hypothetical query nodes.

In an embodiment, the generating of the one or more hypothetical queries may be configured to generate the one or more hypothetical queries using a large language model (LLM).

In an embodiment, the generating of the embedding vectors may include: generating initial embedding vectors from text of the document nodes and the query nodes using an embedding model; and updating the embedding vectors of the document nodes and the query nodes using embedding vectors of adjacent nodes in the graph.

In an embodiment, the updating may be configured to update the embedding vectors of the document nodes and the query nodes using attention-based message passing.

In an embodiment, the updating may be configured to repeatedly apply message passing to the document nodes and the query nodes a selected number of times.

In an embodiment, the retrieving of the one or more documents may include: generating an input embedding vector corresponding to the input query; calculating first relevance scores between the document nodes and the input query based on similarities between the embedding vectors of the query nodes connected to the document nodes in the graph and the input embedding vector; calculating second relevance scores between the document nodes and the input query based on similarities between the embedding vectors of the document nodes in the graph and the input query; and selecting one or more documents corresponding to the input query from the plurality of documents based on the first relevance scores and the second relevance scores.

In an embodiment, in a case in which there are a plurality of query nodes connected to a particular document node in the graph, a first relevance score of the particular document node may be set as a maximum value of the similarities between the plurality of query nodes connected to the particular document node and the input embedding vector.

In an embodiment, the selecting of the one or more documents may be configured to select the one or more documents in ascending order of the first relevance scores, and in a case in which there are documents having a same first relevance score, select documents having higher second relevance scores with priority.

According to example embodiments, provided is a graph-based document retrieval device including: one or more processors; a memory; and one or more programs, wherein the one or more programs are stored in the memory and configured to be executed by the one or more processors, and the one or more programs include instructions for causing operations to be executed. The operations include: generating a graph having a plurality of documents as document nodes and one or more queries associated with each of the plurality of documents as query nodes; generating embedding vectors corresponding to the document nodes and the query nodes; and retrieving one or more documents associated with an input query among the plurality of documents based on the embedding vectors.

In an embodiment, the generating of the graph may include generating an edge between each of the query nodes and a document node associated with each of the query nodes.

In an embodiment, the generating of the graph may include: generating, from a document having no associated queries or a specific or smaller number of associated queries, one or more hypothetical queries associated with the document; and adding the generated one or more hypothetical queries to the graph as hypothetical query nodes.

In an embodiment, the generating of the one or more hypothetical queries may be configured to generate the one or more hypothetical queries using a large language model (LLM).

In an embodiment, the generating of the embedding vectors may include: generating initial embedding vectors from text of the document nodes and the query nodes using an embedding model; and updating the embedding vectors of the document nodes and the query nodes using embedding vectors of adjacent nodes in the graph.

In an embodiment, the updating may be configured to update the embedding vectors of the document nodes and the query nodes using attention-based message passing.

In an embodiment, the updating may be configured to repeatedly apply message passing to the document nodes and the query nodes a selected number of times.

In an embodiment, the retrieving of the one or more documents may include: generating an input embedding vector corresponding to the input query; calculating first relevance scores between the document nodes and the input query based on similarities between the embedding vectors of the query nodes connected to the document nodes in the graph and the input embedding vector; calculating second relevance scores between the document nodes and the input query based on similarities between the embedding vectors of the document nodes in the graph and the input query; and selecting one or more documents corresponding to the input query from the plurality of documents based on the first relevance scores and the second relevance scores.

In an embodiment, in a case in which there are a plurality of query nodes connected to a particular document node in the graph, a first relevance score of the particular document node may be set as a maximum value of the similarities between the plurality of query nodes connected to the particular document node and the input embedding vector.

In an embodiment, the selecting of the one or more documents may be configured to select the one or more documents in ascending order of the first relevance scores, and in a case in which there are documents having a same first relevance score, select documents having higher second relevance scores with priority.

According to example embodiments, provided is a non-transitory computer-readable recording medium storing computer program, which, when executed by one or more processors, causes the one or more processors to perform: generating a graph having a plurality of documents as document nodes and one or more queries associated with each of the plurality of documents as query nodes; generating embedding vectors corresponding to the document nodes and the query nodes; and retrieving one or more documents associated with an input query among the plurality of documents based on the embedding vectors.

According to embodiments of the disclosure, constructing a graph database which includes all queries and documents as nodes, as well as dynamically updating embedding information of each node in a graph structure via attention-based message passing, enables a document retrieval which may adapt to new data without the need to retrain a pre-trained embedding model.

According to embodiments of the disclosure, using a two-step document retrieval method may improve the retrieval accuracy by evaluating the relevance between queries linked to documents in the graph structure and then, for documents having the same relevance, additionally considering the relevance between the documents and the queries.

Furthermore, according to embodiments of the disclosure, new query-document relationships may be reflected in the graph based on feedback collected from users, thereby improving retrieval performance as the system operates. In addition, in embodiments of the disclosure, since an LLM is used only in the graph construction operation, resource consumption in the inference process may be reduced, and the cost efficiency of the entire system may be improved.

### DESCRIPTION OF DRAWINGS

The above and other objectives, features, and advantages of the disclosure will be more clearly understood from the following detailed description, taken in conjunction with the accompanying drawings, in which:

FIG. 1 is a block diagram illustrating a graph-based document retrieval device according to embodiments;

FIG. 2 is a block diagram illustrating a graph generating process by the graph generator according to embodiments;

FIG. 3 is a block diagram illustrating a hypothetical query generating process by the graph generator according to embodiments;

FIGS. 4 and 5 illustrate graphs generated by the graph generator according to embodiments;

FIG. 6 is a block diagram illustrating a document retrieval process using a graph by the document retriever according to some embodiments;

FIG. 7 is a flowchart illustrating a graph-based document retrieval method according to embodiments;

FIG. 8 is a flowchart specifically illustrating the embedding vector generating operation according to embodiments;

FIG. 9 is a flowchart specifically illustrating the document retrieval operation by the document retriever according to embodiments; and

FIG. 10 is a block diagram illustrating a computing environment including a computing device suitable for use in example embodiments.

### DETAILED DESCRIPTION

Hereinafter, specific embodiments of the present disclosure will be described with reference to the accompanying drawings. The following detailed description is provided to assist in gaining a comprehensive understanding of at least one of a method, a device, and a system to be described hereafter. However, the detailed description is merely exemplary, and the disclosure is not limited thereto.

In the description of embodiments of the disclosure, a detailed description of known technologies related to the disclosure will be omitted in a case in which the subject matter of the disclosure may be rendered unclear thereby. Terms to be used hereinafter will be defined in consideration of functions thereof in embodiments of the disclosure, but may vary depending on the intentions of users or operators, as well as practices. Therefore, the terms shall be defined on the basis of the descriptions throughout the specification. The terms used in the detailed description shall be interpreted as being illustrative, while not being limitative, of embodiments of the disclosure. Unless clearly used otherwise, a singular form includes a plural meaning. It shall be understood that expressions such as “comprise,” “include,” and “have,” as used herein, are for indicating particular features, numbers, steps, operations, elements, or a portion or combinations thereof and are not to be interpreted as excluding the presence or possibility of one or more features, numbers, steps, operations, elements, or a portion or combinations thereof other than those described above.

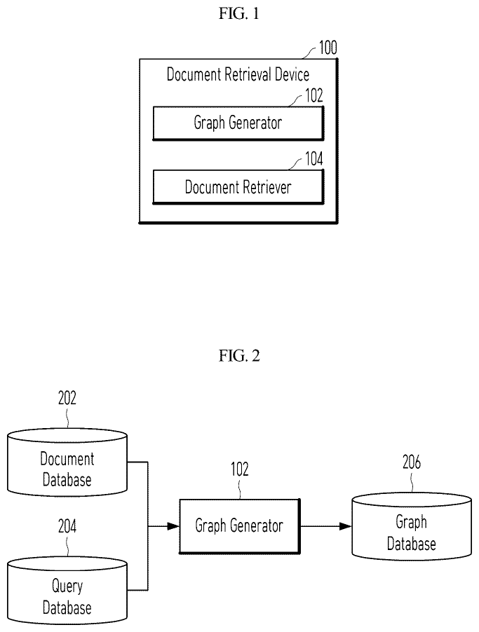

FIG. 1 is a block diagram illustrating a graph-based document retrieval device 100 according to some embodiments. As shown in FIG. 1, the document retrieval device 100 includes a graph generator 102 and a document retriever 104.

The graph generator 102 generates a graph using a plurality of documents and one or more queries associated with each of the documents. In an embodiment, the graph generator 102 generates a graph having a plurality of documents as document nodes and one or more queries associated with each of the documents as query nodes. For example, the graph generator 102 is configured to generate a graph by configuring not only documents, but also queries, as nodes.

The graph generator 102 may generate undirected edges each connecting a query node on the graph and a document node associated with the query node. For example, the edges of the graph connect queries and documents associated with the queries in an undirected manner, and there are no edges connecting documents or queries.

As described above, once the nodes (e.g., document nodes and query nodes) and edges of the graph are generated, the graph generator 102 generates embedding vectors corresponding to the document nodes and the query nodes of the graph. Features regarding the generation of the embedding vectors are described in detail below.

The document retriever 104 receives an input query from a user and retrieves one or more documents associated with the input query, based on the embedding vectors of the respective nodes of the graph generated by the graph generator 102. For example, the document retriever 104 may be configured to retrieve the documents associated with the input query by identifying K number of documents having a high degree of relevance to the input query (where K is a natural number greater than or equal to 1). The retrieved documents may be provided to the user who entered the query.

FIG. 2 is a block diagram illustrating a graph generating process by the graph generator 102 according to embodiments. The graph generator 102 is configured to generate a graph having a plurality of documents provided from a document database 202 as document nodes and a plurality of queries provided from a query database 204 as query nodes and store the graph in a graph database 206. As described above, edges may be formed between the query nodes in the graph and the document nodes associated with the query nodes. In this case, the association between a particular query node and a particular document node may mean that the particular document was provided in response to a feature query entered by a user in the past and that the user responded positively to the provided document. For example, queries and documents may be associated with each other depending on whether there is user feedback regarding the documents provided in response to the user queries, whether the documents are actually used, or the like. In other words, the edges in the graph may represent labeled pairs that depict correct answer relationships between particular queries and associated documents.

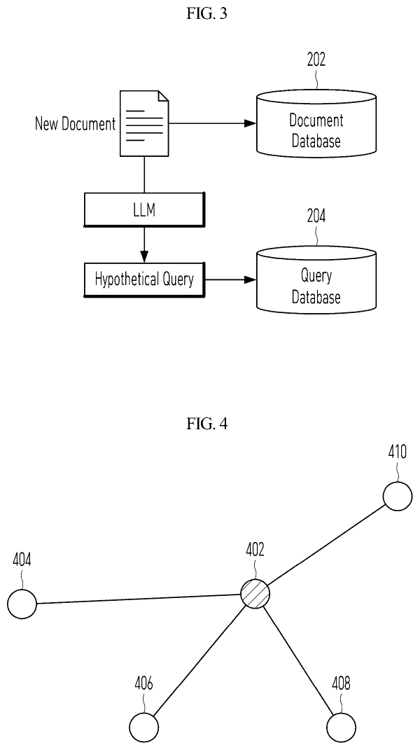

FIG. 3 is a block diagram illustrating a hypothetical query generating process by the graph generator 102 according to embodiments. The graph generator 102 may be configured to, in a case in which any document(s) having no associated queries or a specific or smaller number of associated queries is present among the documents stored in the document database 202, generate one or more hypothetical queries associated with the document and add the generated hypothetical queries to the graph as hypothetical query nodes.

For example, as shown in FIG. 3, in a case in which it is determined that there are no queries or an insufficient number of queries associated with a new document to be stored in the document database 202, the graph generator 102 may generate one or more hypothetical queries from the new document. In an embodiment, the graph generator 102 may be configured to generate one or more hypothetical queries using a large language model (LLM). Conventional document retrieval methods such as HyDE use an LLM during the document retrieval operation, which incurs costs due to excessive uses of time and resources in the retrieval process. In contrast, embodiments of the disclosure use an LLM only during the graph construction process, thereby relatively reducing costs incurred. The generated hypothetical queries may be added to the query database 204 and be included in query nodes in the subsequent graph generation process.

FIGS. 4 and 5 illustrate graphs generated by the graph generator 102 according to embodiments. In the graphs shown in FIGS. 4 and 5, nodes having diagonal stripes therein represent document nodes, and nodes having white interiors represent query nodes. As described above, the graph generator 102 may connect the document nodes and the query nodes associated with the document nodes using undirected edges. For example, the edges of the graph connect queries and documents associated with the queries in an undirected manner, and there are no edges connecting the documents or the queries.

FIG. 4 shows an example graph in which a plurality of query nodes 404, 406, 408, and 410 are connected to a single document node 402. In a case in which a single document is associated with a plurality of queries, the document node may be only connected to the associated query nodes without being connected to other document nodes.

FIG. 5 shows an example graph in which two or more document nodes are connected via a query node. In the example diagram of FIG. 5, a document node 502 is connected to query nodes 506 and 508, and a document node 504 is connected to query nodes 508, 510, and 512. That is, the query node 508 is connected to both the document nodes 502 and 504.

In the case of multi-hop passage retrieval, multi-API retrieval, or the like, a single query may be associated with a plurality of documents. In such cases, as shown in FIG. 5, two or more document nodes may be connected to each other via a single query node.

The graph structure that has been explained so far may be expressed as follows:

G=(V,E)

V=V_{D}∪V_{Q}

E={(v_{d},v_{q})|v_{d}∈V_{D} is relevant to v_{q}∈V_{Q}.}

Here, V_{D} denotes a set of document nodes, and V_{Q} denotes a set of query nodes.

As described above, once the document nodes, the query nodes, and the edges connecting the document nodes and the query nodes are formed in the graph, the graph generator 102 generates embedding vectors corresponding to the document nodes and the query nodes included in the graph.

First, the graph generator 102 generates initial embedding vectors from the text of the document nodes and the query nodes using an embedding model. In an embodiment, the graph generator 102 may generate initial embedding vectors by inputting the text of the document nodes or the query nodes to the embedding model. In this case, the embedding model refers to a model for representing text data as numerical vector spaces. In some embodiments, the type of embedding vectors is not particularly limited, and various types of embedding models capable of generating embedding vectors from text, such as Word2Vec, BERT, SBERT, and SimCSE, may be used without limitation depending on the characteristics of the documents or the queries.

Thereafter, the graph generator 102 generates final embedding vectors by updating the initial embedding vectors generated. In an embodiment, the graph generator 102 may update the embedding vectors of the document nodes and the query nodes using the embedding vectors of the adjacent nodes depending on the graph structure. In this case, the graph generator 102 may update the embedding vectors of the document nodes and the query nodes using attention-based message passing. In an embodiment, the graph generator 102 may use the attention-based message passing which is available without parameter learning, but embodiments of the disclosure are not limited thereto, and it is also possible to use any attention method. In an embodiment, the graph generator 102 may generate embedding vectors by repeatedly applying message passing to the document nodes and the query nodes a selected number of times.

The attention-based message passing described above may be explained mathematically as follows:

$${h}_{i}^{t} = w {h}_{i}^{t - 1} + ( 1 - w ) {\sum }_{j ∈ {N}_{i}} {a}_{i j}^{t - 1} {h}_{j}^{t - 1} \qquad Equation 2$$

Here, hit denotes the embedding vector of the i^{th} node after t^{th} message passing, and hᵢ⁰ denotes the initial embedding vector of the i^{th} node. Ni denotes a set of adjacent nodes of the i^{th} node, and w is a weight that determines how much information of existing nodes to retain. The larger w is, the greater the proportion of information from existing nodes is reflected than that from the adjacent nodes. Furthermore, aᵢⱼ^{t-1} denotes the attention value between the i^{th} node and the j^{th} node, and may be calculated using the following equation:

$${a}_{i j}^{t - 1} = \frac{exp ( \frac{s i m ( {h}_{i}^{t - 1} , {h}_{j}^{t - 1} )}{T} )}{{\sum }_{k ∈ {N}_{i}} exp ( \frac{s i m ( {h}_{i}^{t - 1} , {h}_{k}^{t - 1} )}{T} )} \qquad Equation 3$$

Here, T refers to temperature, which is one of the hyperparameters used when calculating attention.

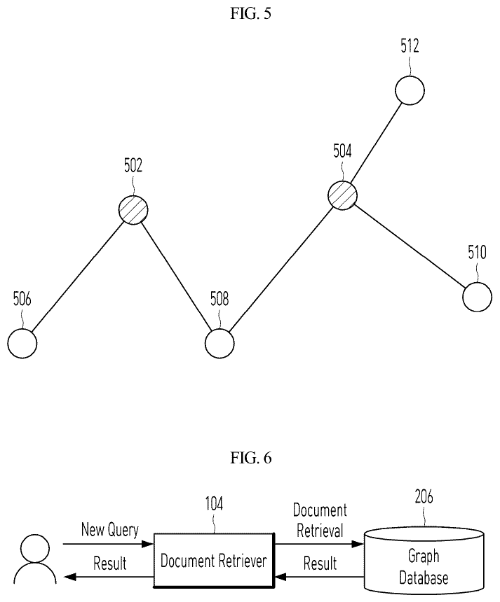

FIG. 6 is a block diagram illustrating a document retrieval process using a graph by the document retriever 104 according to embodiments of the disclosure. In some embodiments, the document retriever 104 may be configured to retrieve a document in two operations reflecting the structure of a graph generated by the graph generator 102.

In the first operation, the document retriever 104 generates an input embedding vector corresponding to an input user query, and calculates the similarities between embedding vectors of query nodes connected to document nodes in the graph and the input embedding vector. The document retriever 104 sets the similarities between the embedding vectors of the query nodes connected to the document nodes and the input embedding vector as first relevance scores of the document nodes. At this time, in a case in which a plurality of query nodes are connected to a single document node, the first relevance score of the document node may be set as the maximum value of the relevance scores calculated from the plurality of query nodes. The first relevance score s₁ between document d and user query q may be expressed as s₁(q, d) and calculated using the following equation:

$${s}_{1} ( q , d ) = {max}_{i ∈ {N}_{{v}_{d}}} sim ( {h}_{q} , {h}_{i}^{t} ) \qquad Equation 4$$

Here, N_{vd} refers to a query node adjacent to a document node v_{d}, and h_{q} refers to the text of an input user query, which is converted into an embedding vector.

The document retriever 104 sorts the first relevance scores of the respective calculated document nodes in descending order.

The second operation may be performed to compare the relevance scores of documents having the same first relevance score. In this operation, the document retriever 104 calculates the similarities between the embedding vectors of the respective document nodes in the graph and the input embedding vector, and sets the similarities as second relevance scores. The second relevance score s₂ between a specific document d and a user query q may be expressed as s₂(q, d) and may be calculated using the following equation:

s₂(q,d)=sim(h_{q},hᵥ_{_{d}}^{t}) Equation 5

Here, h_{vd}^{t} is the embedding vector of the document node v_{d}.

The document retriever 104 reorders the document nodes having the same first relevance score according to the second relevance score, among the document nodes sorted in descending order according to the first relevance score.

The document retriever 104 may select one or more documents corresponding to the input user query from a plurality of documents based on the calculated first and second relevance scores. In an implementation, the document retriever 104 may be configured to select the one or more documents in ascending order of the first relevance scores, and in a case in which there are documents having the same first relevance score, select documents having higher second relevance scores with priority. For example, the document retriever 104 may select K number of documents having higher first relevance scores from a set of documents sorted according to the first relevance score in the first operation and then re-sorted according to the second relevance score in the second operation, and output the selected K number of documents having higher first relevance scores as retrieval results.

The graph generator adds documents to which the user responded positively, among the K number of documents selected by the document retriever 104, and user queries associated with these documents to the document database 202 and the query database 204, and adds the (query and document) pairs to the graph database 206. Accordingly, the retrieval history of the user accumulated in the document retrieval device 100 may be continuously reflected as labeled data on the graph.

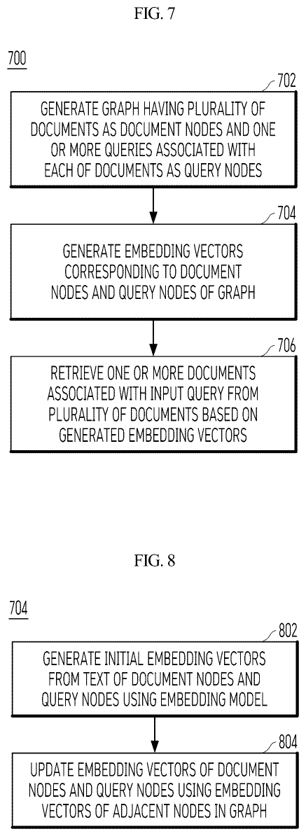

FIG. 7 is a flowchart illustrating a graph-based document retrieval method 700 according to embodiments. The method shown may be performed by a computing device, such as the graph-based document retrieval device 100, including one or more processors and a memory which stores one or more programs to be executed by the one or more processors. In the flowchart shown, the method or process is shown being divided into a plurality of operations, but at least some of the operations may be performed in a different order, combined with other operations, omitted, divided into sub-operations, or added or performed with one or more additional operations not shown.

In operation 702, the graph generator 102 generates a graph having a plurality of documents as document nodes and one or more queries associated with each of the documents as query nodes.

In operation 704, the graph generator 102 generates embedding vectors corresponding to the document nodes and the query nodes of the graph.

In operation 706, the document retriever 104 retrieves one or more documents associated with an input query from the plurality of documents based on the generated embedding vectors.

FIG. 8 is a flowchart specifically illustrating the embedding vector generating operation 704 according to embodiments.

In operation 802, the graph generator 102 generates initial embedding vectors from the text of document nodes and query nodes using a selected embedding model.

In operation 804, the graph generator 102 updates the embedding vectors of the document nodes and the query nodes using the embedding vectors of the adjacent nodes in the graph. As described above, the graph generator 102 may update the embedding vectors of the document nodes and the query nodes using attention-based message passing. Furthermore, the graph generator 102 may repeatedly apply message passing to the document nodes and the query nodes a selected number of times.

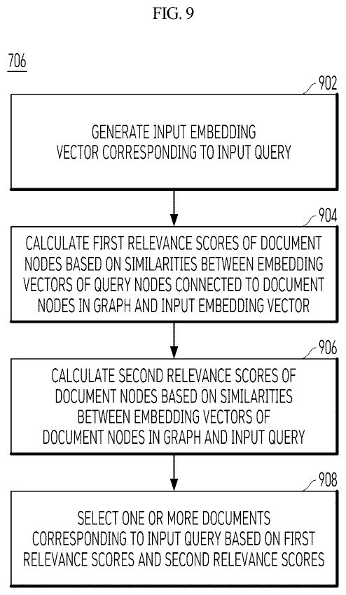

FIG. 9 is a flowchart specifically illustrating the document retrieval operation 706 by the document retriever 104 according to embodiments.

In operation 902, the document retriever 104 generates an input embedding vector corresponding to the input query.

In operation 904, the document retriever 104 calculates first relevance scores between the document nodes and the input query based on the similarities between the embedding vectors of the query nodes connected to the document nodes in the graph and the input embedding vector. In this case, in a case in which there are a plurality of query nodes connected to a particular document node in the graph, the first relevance score of the particular document node may be set as the maximum value of the similarities between the plurality of query nodes connected to the particular document node and the input embedding vector.

In operation 906, the document retriever 104 calculates second relevance scores between the document nodes and the input query based on the similarities between the embedding vectors of the document nodes in the graph and the input query.

In operation 908, the document retriever 104 selects one or more documents corresponding to the input query from the plurality of documents based on the first relevance scores and the second relevance scores. In an embodiment, the document retriever 104 may be configured to select the one or more documents in ascending order of the first relevance scores, and in a case in which there are documents having the same first relevance score, select documents having higher second relevance scores with priority.

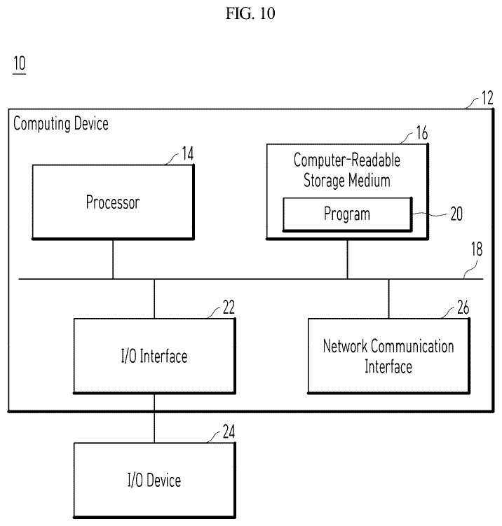

FIG. 10 is a block diagram illustrating a computing environment including a computing device suitable for use in example embodiments. In the illustrated embodiment, respective components may have functions and capabilities other than those described below, and other components not described hereafter may also be included.

A computing environment 10 shown in FIG. 10 includes a computing device 12. In some embodiments, the computing device 12 may be the graph-based document retrieval device 100 according to embodiments. The computing device 12 includes at least one processor 14, a computer-readable storage medium 16, and a communication bus 18. The processor 14 may allow the computing device 12 to operate according to the example embodiments described above. For example, the processor 14 may execute one or more programs stored in the computer-readable storage medium 16. The one or more programs may include one or more computer-executable instructions, which may be configured to enable the computing device 12 to perform operations according to the example embodiments when executed by the processor 14.

The computer-readable storage medium 16 may be configured to store computer-executable instructions, program codes, program data, and/or other suitable forms of information. A program 20 stored in the computer-readable storage medium 16 may include a set of instructions executable by the processor 14. In an embodiment, the computer-readable storage medium 16 may be a memory (e.g., a volatile memory such as a random access memory (RAM), a non-volatile memory, or a combination thereof), one or more magnetic disk storage devices, optical disk storage devices, flash memory devices, other types of storage media which may be accessed by the computing device 12 and store intended information, or a suitable combination thereof.

The communication bus 18 may interconnect various components of the computing device 12 to each other, such as the processor 14 and the computer-readable storage medium 16.

The computing device 12 may also include one or more input/output (I/O) interfaces 22 providing an interface for one or more I/O devices 24 and one or more network communication interfaces 26. The I/O interface 22 and the network communication interfaces 26 may be connected to the communication bus 18. The illustrated I/O devices 24 may include input devices, such as a pointing device (e.g., a mouse or a track pad), a keyboard, a touch input device (e.g., a touch pad or a touch screen), a voice or sound input device, various types of sensors, and/or an image-capturing device, and/or output devices, such as a display device, a printer, a speaker, and/or a network card. Each of the illustrated I/O devices 24 may be included in the computing device 12 as one component of the computing device 12 or connected to the computing device 12 as a device separate from the computing device 12.

Although the exemplary embodiments of the disclosure have been described in detail hereinabove, a person having ordinary knowledge in the technical field to which the disclosure pertains will appreciate that various modifications are possible to the foregoing embodiments without departing from the scope of the disclosure. Therefore, the scope of the disclosure shall not be limited to the foregoing embodiments but shall be defined by the appended Claims and equivalents thereof.

What is claimed is:

1. A graph-based document retrieval method performed by a computing device, wherein the computing device comprises:
one or more processors; and
a memory which stores one or more programs to be executed by the one or more programs,
the graph-based document retrieval method comprising:
generating a graph having a plurality of documents as document nodes and one or more queries associated with each of the plurality of documents as query nodes;
generating embedding vectors corresponding to the document nodes and the query nodes; and
retrieving one or more documents associated with an input query among the plurality of documents based on the embedding vectors.

2. The graph-based document retrieval method of claim 1, wherein the generating of the graph comprises generating an edge between each of the query nodes and a document node associated with each of the query nodes.

3. The graph-based document retrieval method of claim 1, wherein the generating of the graph comprises:
generating, from a document having no associated queries or a specific or smaller number of associated queries, one or more hypothetical queries associated with the document; and
adding the generated one or more hypothetical queries to the graph as hypothetical query nodes.

4. The graph-based document retrieval method of claim 3, wherein the generating of the one or more hypothetical queries is configured to generate the one or more hypothetical queries using a large language model.

5. The graph-based document retrieval method of claim 1, wherein the generating of the embedding vectors comprises:
generating initial embedding vectors from text of the document nodes and the query nodes using an embedding model; and
updating the embedding vectors of the document nodes and the query nodes using embedding vectors of adjacent nodes in the graph.

6. The graph-based document retrieval method of claim 5, wherein the updating is configured to update the embedding vectors of the document nodes and the query nodes using attention-based message passing.

7. The graph-based document retrieval method of claim 6, wherein the updating is configured to repeatedly apply message passing to the document nodes and the query nodes a selected number of times.

8. The graph-based document retrieval method of claim 1, wherein the retrieving of the one or more documents comprises:
generating an input embedding vector corresponding to the input query;
calculating first relevance scores between the document nodes and the input query based on similarities between the embedding vectors of the query nodes connected to the document nodes in the graph and the input embedding vector;
calculating second relevance scores between the document nodes and the input query based on similarities between the embedding vectors of the document nodes in the graph and the input query; and
selecting one or more documents corresponding to the input query from the plurality of documents based on the first relevance scores and the second relevance scores.

9. The graph-based document retrieval method of claim 8, wherein in a case in which there are a plurality of query nodes connected to a particular document node in the graph, a first relevance score of the particular document node is set as a maximum value of the similarities between the plurality of query nodes connected to the particular document node and the input embedding vector.

10. The graph-based document retrieval method of claim 8, wherein the selecting of the one or more documents is configured to select the one or more documents in ascending order of the first relevance scores, and in a case in which there are documents having a same first relevance score, select documents having higher second relevance scores with priority.

11. A graph-based document retrieval device comprising:
one or more processors;
a memory; and
one or more programs,
wherein the one or more programs are stored in the memory and configured to be executed by the one or more processors, and
the one or more programs comprise instructions for causing operations to be executed, wherein the operations comprise:
generating a graph having a plurality of documents as document nodes and one or more queries associated with each of the plurality of documents as query nodes;
generating embedding vectors corresponding to the document nodes and the query nodes; and
retrieving one or more documents associated with an input query among the plurality of documents based on the embedding vectors.

12. The graph-based document retrieval device of claim 11, wherein the generating of the graph comprises generating an edge between each of the query nodes and a document node associated with each of the query nodes.

13. The graph-based document retrieval device of claim 11, wherein the generating of the graph comprises:
generating, from a document having no associated queries or a specific or smaller number of associated queries, one or more hypothetical queries associated with the document; and
adding the generated one or more hypothetical queries to the graph as hypothetical query nodes.

14. The graph-based document retrieval device of claim 11, wherein the generating of the embedding vectors comprises:
generating initial embedding vectors from text of the document nodes and the query nodes using an embedding model; and
updating the embedding vectors of the document nodes and the query nodes using embedding vectors of adjacent nodes in the graph.

15. The graph-based document retrieval device of claim 14, wherein the updating is configured to update the embedding vectors of the document nodes and the query nodes using attention-based message passing.

16. The graph-based document retrieval device of claim 15, wherein the updating is configured to repeatedly apply message passing to the document nodes and the query nodes a selected number of times.

17. The graph-based document retrieval device of claim 11, wherein the retrieving of the one or more documents comprises:
generating an input embedding vector corresponding to the input query;
calculating first relevance scores between the document nodes and the input query based on similarities between the embedding vectors of the query nodes connected to the document nodes in the graph and the input embedding vector;
calculating second relevance scores between the document nodes and the input query based on similarities between the embedding vectors of the document nodes in the graph and the input query; and
selecting one or more documents corresponding to the input query from the plurality of documents based on the first relevance scores and the second relevance scores.

18. The graph-based document retrieval device of claim 17, wherein in a case in which there are a plurality of query nodes connected to a particular document node in the graph, a first relevance score of the particular document node is set as a maximum value of the similarities between the plurality of query nodes connected to the particular document node and the input embedding vector.

19. The graph-based document retrieval device of claim 17, wherein the selecting of the one or more documents is configured to select the one or more documents in ascending order of the first relevance scores, and in a case in which there are documents having a same first relevance score, select documents having higher second relevance scores with priority.

20. A non-transitory computer-readable recording medium storing computer program, which, when executed by one or more processors, causes the one or more processors to perform:
generating a graph having a plurality of documents as document nodes and one or more queries associated with each of the plurality of documents as query nodes;
generating embedding vectors corresponding to the document nodes and the query nodes; and
retrieving one or more documents associated with an input query among the plurality of documents based on the embedding vectors.
